(19) United States
(12) Patent Application Publication
(10) Pub. No.: US 2010/0182509 A1
(43) Pub. Date: Jul. 22, 2010

(54) REMOVING 2FH CROSS TALK FOR TV

(75) Inventors: Frank Van Rens, Horst (NL); Hans Joosten, Roermond (NL)

Correspondence Address: DLA PIPER LLP (US), 2000 UNIVERSITY AVENUE, EAST PALO ALTO, CA, 94303, US

(73) Assignee: NXP B.V., Eindhoven (NL)

(21) Appl. No.: 12/601,291

(22) PCT Filed: Jun. 6, 2008
(86) PCT No.: PCT/IB2008/052233

§ 371 Date: Nov. 23, 2009

(30) Foreign Application Priority Data
Jun. 11, 2007 (EP) 07110002.8

(51) Int. Cl. H04N 5/00

(52) U.S. Cl. 348/607; 348/E05.001

(57) ABSTRACT

Artifacts occur in the images rendered on a 100 Hz TV as a result of the vertical and horizontal blanking intervals. These intervals cause transitions between high activity and low activity of the TV's digital processing parts which in return cause disturbances on the power supply lines. By keeping the digital processing parts active during the blanking intervals, the artifacts are removed.

### FIELD OF THE INVENTION

The invention relates to a system for processing an analog input signal representing a sequence of multiple images for rendering on a display monitor, wherein the system comprises an analog sub-system for receiving the analog input signal and converting the analog input system into a digital input signal, and a digital sub-system for digitally processing the digital input signal. The invention is especially relevant to TV sets with CRT or LCD display monitors, set-top boxes e.g., those that enable to play downloaded music and videos on a home stereo or a television, PC monitors, video converters, display monitors, PC cards, etc.

### BACKGROUND ART

Electronic system design has evolved towards using a multiple-chip module (MCM) or a “system-on-chip” (SoC) module. This means that a single module accommodates most or all data processing and storage capabilities required to implement the system functionality. Advantages of such an approach reside in smaller size, lower power consumption, fewer physical components, lower assembly costs and shorter assembly times, broader field of applicability, etc.

### SUMMARY OF THE INVENTION

An example of such electronic systems that benefit from the usage of multiple-chip modules and single-chip modules is an electronic display monitor. However, the inventors have found that especially in a hybrid system that processes both analog and digital signals, the multiple-chip and single-chip configurations may bring about problems that are absent in multiple-modules designs. Problems arise in the multiple-chip module configurations and SoC configurations, at least partly owing to the closer proximity of circuits whose activities affect each other's operations in an undesirable manner, e.g., owing to the shared use of physical components such as power lines and/or owing to the coupling between circuits through electromagnetic radiation. These problems may result in perceptible artifacts in the images displayed, and/or perceptible artifacts in the audio accompanying the rendering of the images.

Consider a digital TV system having a SoC configuration. The inventors have analyzed the following occurrences of artifacts in the display area of the monitor. As a first example, note that the horizontal frequency of the output signal is twice the incoming frequency because of the de-interlacing function. Together with a slight horizontal delay, the blanking of the digital video output can be visible in the active part of the display area as two vertical bars because with the double horizontal frequency. As a second example of artifacts, there can be a small ripple on the chip's supply lines, owing to the absence of digital activity during vertical blanking. As known, video data is stored for only one or a few horizontal lines. In case of a line memory, this line will be in the active display area, as the delay between analog input and digital output is only one or a few line periods. There can be a horizontal line at the top of the screen if the analog front-end IC has a poor power-supply rejection-ratio. Filtering does not help for these low frequencies. The problem could be solved by taking extra measures regarding the power supply distribution and by careful design of the DC/DC converter for the chip's power supply. As a third example, note that the intermediate-frequency (IF) signals are sensitive of disturbances especially for the SECAM standard, which is using amplitude modulation (AM) for the sound component in the TV signal. The signals after the SAW filter (surface acoustic wave) are the weakest signals in the system. Although the signals are applied symmetrically to the front-end, they still suffer from the electromagnetic radiation caused by the digital video interface.

In modern TV systems, whether based on cathode ray tube (CRT) or liquid crystal display (LCD), more and more parts are running on 2FH, i.e., twice the input frequency. In a 50 Hz TV, the image is scanned 50 times per second. Every 1/25 of a second, a single complete image is formed. First all the odd lines are formed within 1/50 second, then all the even lines are formed within 1/50 second. This gives rise to an undesired visible effect, namely, a flickering image. In 100 Hz TVs the frequency is doubled to solve the problem of area flicker occurring in a 50 Hz TV. In a 100 Hz TV, the images are scanned at a rate of 100 times per second. An incoming image is stored digitally in a memory so that it can be written a second time to the display screen. Accordingly, the group of odd lines of an image is written twice, then the group of even lines of the same image is written twice, then the group of odd lines of a next image is written twice, and so on. Line flicker is still noticeable in 100 Hz TVs: Horizontal edges of objects being displayed seem to jump up and down as a result of the ongoing changes between odd and even lines being written. The technology referred to as “Digital Scan”, in combination with 100 Hz, solves this problem. In Digital Scan, first the odd lines of an image are written to the screen, then the even lines are written, then the odd lines and then the even lines again. With respect to the 100 Hz, the order of the group of lines is changed in order to double the frequency of the line changes.

Since 100 Hz (2FH) is exactly twice the original 50 Hz, all disturbances coming from the 2FH domain can give rise to highly visible artifacts on the display screen. The inventors have found that the main contribution to these artifacts finds its origin in the phase wherein the system is in both horizontal and vertical blanking. The inventors have realized that during these blanking periods the chip's power supplies are cleaner due to lower data-processing activity of the system. When the system comes out the blanking period the power supplies are getting slowly disturbed again. The transition from low activity to high activity is causing visual artifacts on the screen.

The inventors therefore propose to keep the chip's power supply lines during the blanking periods at the same dirty level as between the blanking periods by means of writing additional data during the blanking periods. Since there is now no transition anymore the visual artifacts are eliminated.

If the system keeps processing data during the blanking intervals, the disturbances stemming from cross-talk and/or ripples on the shared supply lines has a frequency spectrum that is different from the spectrum in the scenario wherein the data processing is put on hold during the blanking intervals. Low frequencies in the disturbances are then practically removed and what disturbances remain are in the higher frequency range and not visible in the image rendered. As an additional bonus, decoupling capacitors in the chip's power supply do not have to filter low frequencies and hence can be smaller.

More specifically, the inventors propose a system for processing an analog input signal representing a sequence of multiple images for rendering on a display monitor. Each image is made up of odd lines and even lines. Each image is rendered by rendering the odd lines more than once and the even lines more than once. The system comprises an analog sub-system for receiving the analog input signal and converting the analog input system into a digital input signal. The system comprises a digital sub-system for digitally processing the digital input signal. The system is operative to keep the digital sub-system processing during a blanking interval so as to maintain a level of power consumption of the digital sub-system substantially independent of an occurrence of the blanking interval. Preferably, the system keeps the digital sub-system processing during both the horizontal and the vertical blanking intervals.

The invention reduces artifacts in the rendered image that result from 2FH cross-talk, through electromagnetic radiation between the digital and analog sub-systems or through the analog sub-system and the digital sub-system having a shared power supply line or a shared ground line that servers as a conduit for disturbances. The invention is especially favorable for systems, wherein the analog sub-system and the digital sub-system are accommodated within a single electronic device, e.g., an MCM, and for systems, wherein the analog sub-system and the digital sub-system are accommodated in a single semiconductor substrate, e.g., an SoC.

The invention also relates to software for being installed on a system, e.g., a digital TV or a PC, for processing an analog input signal representing a sequence of multiple images for rendering on a display monitor. Each image is made up of odd lines and even lines. Each image is rendered by rendering the odd lines more than once and the even lines more than once. The system comprises an analog sub-system for receiving the analog input signal and converting the analog input system into a digital input signal. The system comprises a digital sub-system for digitally processing the digital input signal. The software comprises instructions to keep the digital sub-system processing during a blanking interval so as to maintain a level of power consumption of the digital sub-system substantially independent of an occurrence of the blanking interval. Accordingly, video processing digital equipment can be upgraded, e.g., as an after-market add-on, by installing the software so as to remove the rendering artifacts.

The invention may in particular be relevant to mobile devices accommodating a system as described above, e.g., mobile TV whether as a dedicated device or as an application on a mobile phone. Mobile devices for the mass market inherently have a small form-factor and preferably have as few components onboard as possible to reduce assembly costs, so that the SoC approach is highly attractive.

For completeness, reference is made to the publications listed below.

U.S. Pat. No. 5,699,076 relates to a display control method and apparatus for controlling a flat panel display such as a liquid crystal display (LCD) and the like used as a display monitor for a personal computer, and more particularly, to a display control method and apparatus suitable for control of an LCD constituted by two, upper and lower panels. During a vertical blank period, in order to prevent generation of noise lines, a display controller outputs the same video data FVD as that of a display final line as dummy data of a vertical blank period start line, and outputs, in advance, video data to be displayed on a display start line in the next frame cycle as dummy data of a vertical blank period final line. The display controller also output a shift clock together with these dummy data. As a result, both upon a change from the display period to the vertical blank period and upon a change from the vertical blank period to the display period, a video data value difference can be eliminated, and generation of noise lines can be prevented. This publication neither teaches nor suggests the problem that the invention seeks to solve (cross-talk between analog and digital circuitry) and neither relates to 2FH technology.

### BRIEF DESCRIPTION OF THE DRAWING

The invention is explained in further detail, by way of example and with reference to the accompanying drawing, wherein:

FIG. 1 is a block diagram of a digital television receiver;

FIGS. 2-5 illustrate the artifacts occurring in an image when rendered.

Throughout the Figures, similar or corresponding features are indicated by same reference numerals.

### DETAILED EMBODIMENTS

Artifacts occur in the images rendered on a 100 Hz TV as a result of the vertical and horizontal blanking intervals. These intervals cause transitions between high activity and low activity of the TV's digital processing parts which in return cause disturbances on the power supply lines. By keeping the digital processing parts active during the blanking intervals, the artifacts are removed.

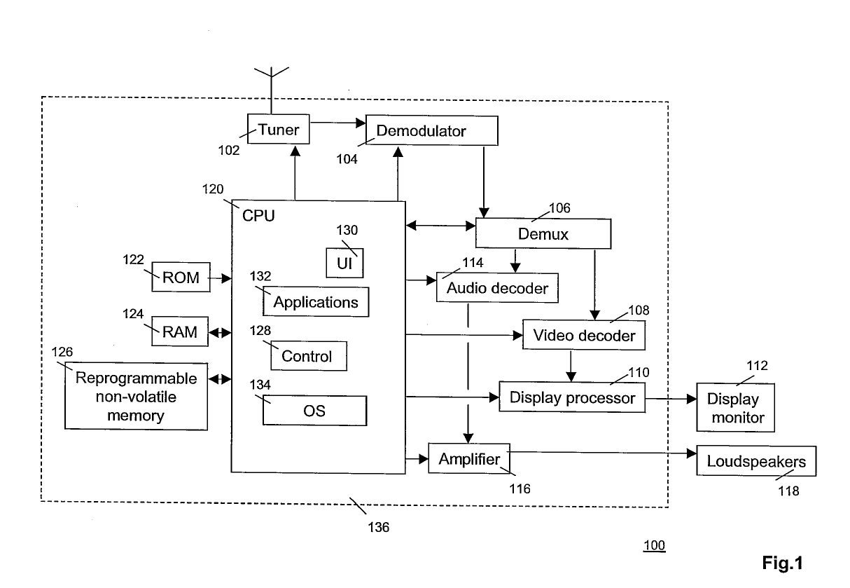

FIG. 1. is a block diagram of a digital TV receiver 100. Receiver 100 includes a tuner 102, a demodulator 104, a demultiplexer 106, a video decoder 108, a display processor 110, a display monitor 112, an audio decoder 114, an amplifier 116, loudspeakers 118, a central processing unit (CPU) 120, a modem 20, a random access memory (hereinafter “RAM”) 21, a non-volatile storage 22, a read-only memory (hereinafter “ROM”) 24, and input devices 25. Each of these features of receiver 100 is well-known to those of ordinary skill in the art; however, descriptions thereof are nevertheless provided herein for the sake of completeness.

Tuner 102 comprises a standard analog RF receiving device configured for receiving an analog signal that includes video data and audio data. Tuner 102 receives the analog signal via, e.g., a cable or an RF link over a particular frequency channel. CPU 120 controls tuner 102 to select the channel. Control is based on data input via one or more of input devices such as a remote control device (not shown), joystick (not shown) or user controls in the control panel (not shown) of receiver 100.

Demodulator 104 receives the analog signal from tuner 102. Demodulator 104 converts the analog signal into digital data packets under control of control data received from CPU 120. These data packets are then supplied to demultiplexer 106. Demultiplexer 106 distributes the data packets between video decoder 108, audio decoder 1114, or CPU 120, depending upon an identified type of the packet. Specifically, CPU 120 identifies whether data packets from demultiplexer 106 include video data, audio data, or other data based on identification headers stored in those packets, and causes the data packets to be allocated accordingly. That is, video data packets are supplied to video decoder 108, audio data packets are supplied to audio decoder 114, and other data packets (e.g., data packets containing data for an EPG or for other software applications available to CPU 120) are supplied to CPU 120.

Alternatively, the data packets are supplied from demodulator 106 directly to CPU 120. In this case, CPU 120 performs the tasks of demultiplexer 106, thereby eliminating the need for separate demultiplexer circuitry.

Video decoder 108 decodes the video data packets received in accordance with control signals, such as timing signals and the like, supplied by CPU 120. The decoded video data is then transmitted to display processor 110.

Display processor 110 can comprise a microprocessor, microcontroller, or the like, which is capable of forming images from video data and of outputting those images to display monitor 112. In operation, display processor 110 outputs a video sequence in accordance with control signals received from CPU 120 based on the decoded video data received from video decoder 108 and based on graphics data received from CPU 120. More specifically, display processor 110 forms images from the decoded video data received from video decoder 108 and from graphics data received from CPU 120, and inserts the images formed from the graphics data at appropriate points in the video sequence defined by the images formed from the decoded video data. With regard to the graphics data, display processor 110 uses image attributes, chroma-keying methods and region-object substituting methods in order to include (i.e., to superimpose) the graphics data in the data stream for the video sequence.

Audio decoder 114 decodes audio data packets associated with video data displayed on display monitor 112 and under control of audio control data received from CPU 120. These audio control data include timing information and the like. Output from audio decoder 114 is provided to amplifier 116. Amplifier 116 comprises an audio amplifier, which adjusts an output audio signal in accordance with audio control signals relating to volume or the like, received from CPU 120 in response to user input via user input devices (not shown). Audio signals adjusted in this manner are then output via loudspeakers 118.

CPU 120 comprises one or more microprocessors, which are capable of executing stored program instructions to control operations of receiver 100. These program instructions comprise parts of software modules (described below) which are stored in an internal memory (not shown) of CPU 120 or in a ROM 122, and which are executed out of a RAM 124. These software modules may be updated via an external source. Receiver 100 further comprises a non-volatile reprogrammable storage 126 for storing, e.g., user preferences such as zapping sequences or favorite channels, as input by a user via the user input devices (not shown), or for storing updates for the program instructions as received from the external source, e.g., via a modem or via the data received via tuner 102.

Examples of software modules with program instructions, executable within the CPU 120, include a control module 128, a user interface module 130, application modules 132, and an operating system module 134. Operating system module 134 controls execution of the various software modules running in CPU 120 and supports communication between these software modules. Operating system module 134 may also control data transfers between CPU 120 and various other components of receiver 100, such as memories 122, 124 and 126. User interface module 130 receives and processes data received from user input devices (not shown), and causes CPU 120 to output control data in accordance therewith. To this end, CPU 120 includes control module 128, which outputs such control data together with other control data, such as those described above, for controlling operation of the various components of receiver 100. CPU 120 may also execute software modules (not shown) to decode video and audio data. In the case that CPU 120 has this capability, demultiplexer 106 provides the video and audio data packets to CPU 120 which performs the functions of video decoder 108 and audio decoder 114. In this case, video decoder circuitry 108 and audio decoder circuitry 114 can be removed as their functionality has been implemented in software.

Application modules 132 comprise software modules for implementing various data processing features available on receiver 100. Application modules 132 can include both manufacturer-installed applications and applications which are downloaded via a modem (not shown) or, alternatively, via the video data stream. Examples of well-known applications that may be included in receiver 100 are an electronic program guide (“EPG”) module and a closed-captioning (“CC”) module.

In an example embodiment of receiver 100, components 102-110, 114, 116, 120-134 are accommodated on a single semiconductor substrate 136. Note that analog signal processing occurs in, e.g., tuner 102, demodulator 104, display processor 110 and amplifier 116 and digital signal processing in demodulator 104, demultiplexer 106, decoders 108 and 114, processor 110 and CPU 120. Analog signal processing also takes place in the analog-to-digital converter (ADC), e.g., clamping and gain correction, in case a separate ADC (not shown) is located downstream of demodulator 104 or upstream of a digital version of demodulator 104.

The coupling of a disturbance in the digital domain to the analog domain can occur in many ways, some examples of which are discussed below, and can give rise to visible or audible artifacts.

In a first example, the power supply common to both analog and digital circuitry can affect the video signal amplitude in case an amplifier in the signal path has a poor power supply rejection ration (PSRR). The PSRR is a quantity that indicates the amount of noise that the amplifier can remove. A ripple on the power supply lines for the digital circuitry can cause a ripple on the power supply to the ADCs for the video and the audio. A supply ripple can affect the gain of amplifier stages in the analog domain. A supply ripple can cause a ripple in the buffer stages in of the analog domain. That is, a supply ripple at the output stage introduces a disturbance of the output signal depending on the PSRR, and the disturbance is related to the supply ripple waveform.

In a second example, the return ground line is common to both analog and digital circuitry. This will cause the common power supply ground for the digital domain and the analog domain to interact. Also, the common ground for the analog signal paths and the digital signal paths will lead to a reduction in the quality of the signals.

In a third example, disturbances can enter the desired/wanted signal itself. High-frequency (HF) noise caused by the digital circuitry and superimposed on a signal can reduce the gain of an amplifier in the signal path via the automatic gain control (AGC) reacting on the HF disturbances. HF noise caused by the digital circuitry and superimposed on a signal can increase the gain of an amplifier through the AGC reacting on disturbances in the absence of digital activity (for example, when the output is blanked in a digital TV). HF noise caused by the digital circuitry and superimposed on a signal can change the gain of an amplifier because the HF noise changes the bias point of the amplifier.

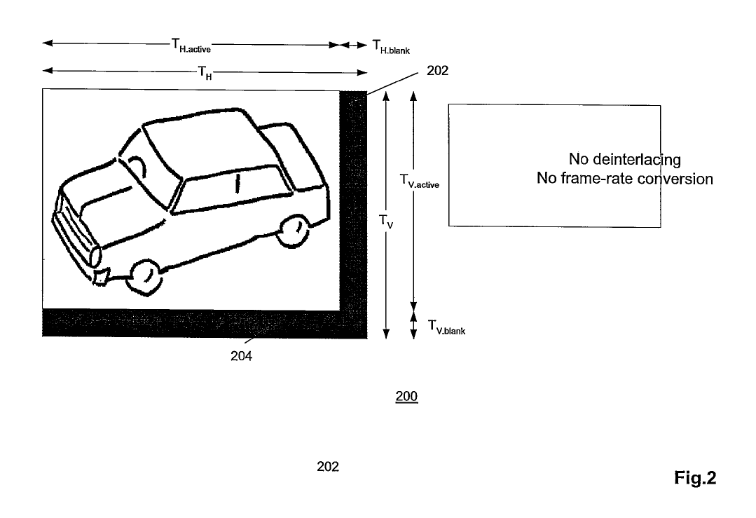

FIGS. 2-5 illustrate some examples of artifacts in the rendered image on display monitor 112 as a result of disturbances in the digital domain.

FIG. 2 illustrates an image 200 rendered on display monitor 112 when there is no interlacing and no frame-rate conversion. The quantity T_{H} indicates the time interval for the processing of the data of a video line (horizontal), and the quantity T_{V} indicates the time interval for the processing of data of a single frame (for progressive scan video) or field (for interlaced video) (vertical). Time period T_{H} consists of an active time period T_{H.active} wherein data is being processed and a horizontal blanking time period, or: horizontal blanking interval, T_{H.blank}. The horizontal blanking interval is the time interval between the writing of two video lines one after the other. Similarly, time period T_{V} consists of an active time period T_{V.active} wherein data for a single frame is being processed and a vertical blanking time period, or: vertical blanking interval, T_{V.blank}. The vertical blanking interval (VBI) is the time interval between the end of the last line of one frame or field of a raster display, and the beginning of the next.

Area 202 indicates the data that is present in the horizontal blanking period but that is not rendered on display monitor 112. Area 204 indicates the data that is present in the vertical blanking period but that is not rendered on display monitor 112.

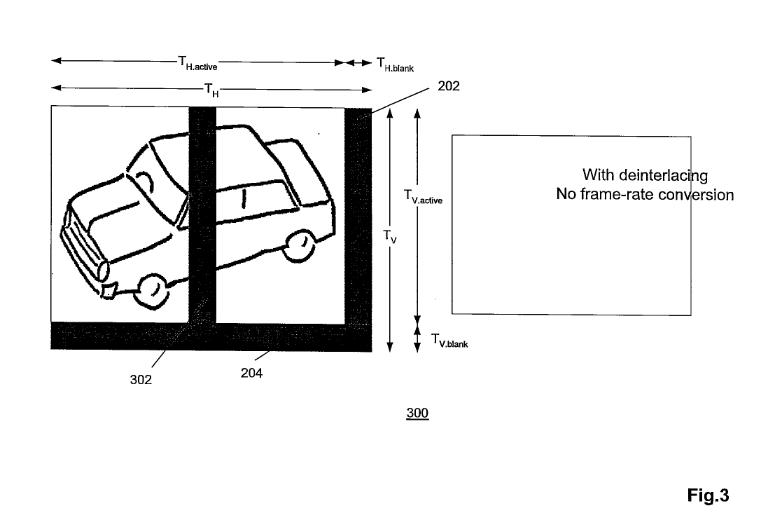

FIG. 3 illustrates an image 300 rendered on display monitor 112 after deinterlacing. Area 302 in the middle of image 300 indicates artifacts due to the 2FH influence of disturbances arising in the digital domain in the horizontal blanking period.

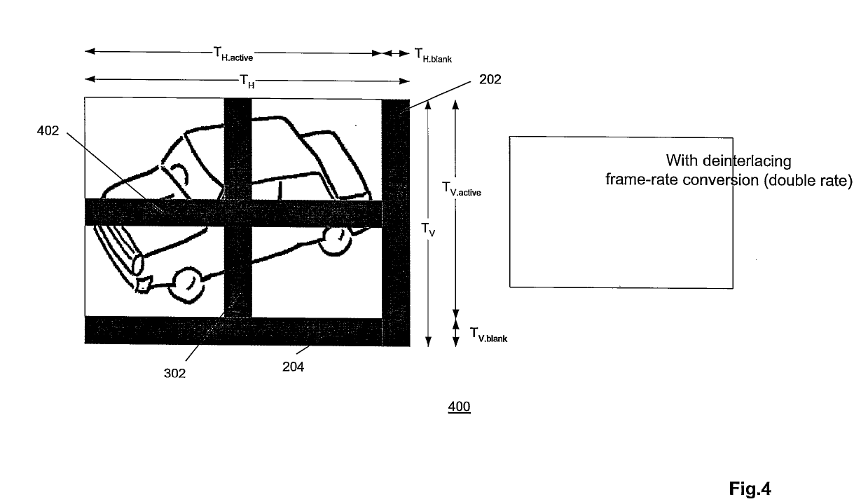

FIG. 4 illustrates an image 400 rendered on display monitor 112 after deinterlacing and double frame rate conversion. In addition to artifacts 302, there now are artifacts 402 as a result of the frame rate conversion.

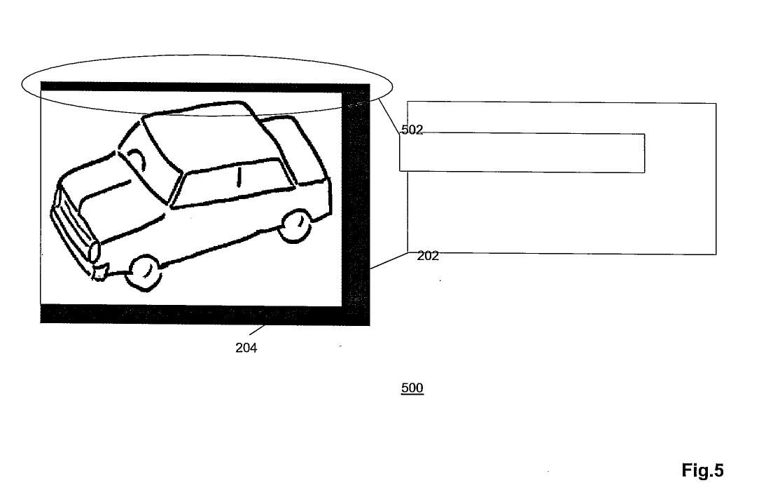

FIG. 5 illustrates in area 502 a horizontal bar where color shift can be observed as a result of the transition of the power supply lines from a state with little or no disturbance to a state with disturbances. That is, in case the digital output signal has a delay of a few horizontal video lines, the timing of an edge in the supply ripple occurs just a few lines after the start of the analog active video area.

Normally all components remain active during the blanking intervals. However, during the blanking intervals, the data processing activity is lower because there is no video data for the blanking intervals. The invention adds artificial data during the blanking intervals, e.g., via video decoder 108 or via display processor 110. This data will not be displayed on display monitor 112 because it will be outside the visible area. The adding of artificial data in the blanking intervals can be done via an OSD image/text (On Screen Display) engine (not shown here), that is implemented as one of software applications 132. Repeating previously received video data can also generate artificial data.

1. A system for processing an analog input signal representing a sequence of multiple images for rendering on a display monitor, wherein
each image is made up of odd lines and even lines and
each image is rendered by rendering the odd lines more than once and the even lines more than once; the system comprising:
an analog sub-system for receiving the analog input signal and converting the analog input system into a digital input signal; and
a digital sub-system for digitally processing the digital input signal;
wherein the system is operative to keep the digital sub-system processing during a blanking interval so as to maintain a level of power consumption of the digital sub-system substantially independent of an occurrence of the blanking interval.

2. The system of claim 1, wherein the analog sub-system and the digital sub-system have a shared power supply line.

3. The system of claim 1, wherein the analog sub-system and the digital sub-system are accommodated within a single electronic device.

4. The system of claim 3, wherein the analog sub-system and the digital sub-system are accommodated on a single semiconductor substrate.

5. The system of claim 1, implemented on a mobile electronic device.

6. The system of claim 1, implemented in at least one of: a TV, a PC, a set-top box, a PC-card, a display monitor.

7. Software for being installed on a system for processing an analog input signal representing a sequence of multiple images for rendering on a display monitor, wherein
each image is made up of odd lines and even lines; and
each image is rendered by rendering the odd lines more than once and the even lines more than once; the system comprising:
an analog sub-system for receiving the analog input signal and converting the analog input system into a digital input signal; and
a digital sub-system for digitally processing the digital input signal; and
wherein the software comprises instructions to keep the digital sub-system processing during a blanking interval so as to maintain a level of power consumption of the digital sub-system substantially independent of an occurrence of the blanking interval.
